(19) United States
(12) Patent Application Publication
(10) Pub. No.: US 2026/0318020 A1
(43) Pub. Date: Oct. 15, 2026

(54) Cleaning Device for Cleaning Ground Areas and Cleaning Method

(71) Applicant: Glatt Gesellschaft mit beschränkter Haftung, Binzen (DE)

(72) Inventors: Reinhard Nowak, Lörrach (DE); Mirko Nowak, Lörrach (DE); Ivo Nowak, Lörrach (DE)

(21) Appl. No.: 19/476,220

(22) PCT Filed: Feb. 22, 2024
(86) PCT No.: PCT/EP2024/054472

§ 371 Date: Oct. 17, 2025

(30) Foreign Application Priority Data
Apr. 20, 2023 (DE) 10 2023 110 064.5

(51) Int. Cl. E01H 1/00; B08B 7/00

(52) U.S. Cl. CPC E01H 1/00; B08B 7/0042

(57) ABSTRACT

A cleaning device used to clean ground areas formed by traffic surfaces and which includes a cleaning vehicle equipped with castor wheels that allow vehicle movement across the ground area to be cleaned and which are at least partially designed as electro-motor operated drive castor wheels. The cleaning device is equipped with a laser cleaning device which includes a laser radiation output unit located on board the cleaning vehicle, from which laser radiation can be emitted for performing a cleaning process, which radiation can be generated by a laser of the laser cleaning device. A device for autonomous vehicle movement of the cleaning vehicle contains control electronics located on board the cleaning vehicle and enables the cleaning device to operate at least largely independently.

### CROSS-REFERENCE TO RELATED APPLICATIONS

This application is the United States national phase of International Patent Application No. PCT/EP2024/054472 filed Feb. 22, 2024, and claims priority to German Patent Application No. 10 2023 110 064.5 filed Apr. 20, 2023, the disclosures of which are hereby incorporated by reference in their entireties.

### BACKGROUND

### Field

The invention relates to a cleaning device for cleaning ground areas, in particular ground areas in the form of traffic surfaces that can be walked on and/or driven on. The invention also relates to a cleaning method for cleaning such ground areas.

### Description of Related Art

Outdoor or interior space ground areas are subject to heavy contamination sooner or later due to their upward orientation. This is especially true for walkable and/or drivable traffic surfaces due to their often high usage. To avoid impairing their usability or simply for aesthetic reasons, it is therefore advisable to thoroughly clean the surfaces of such ground areas from time to time. However, appropriate cleaning measures, which can be carried out using a high-pressure cleaner or brushes, for example, are very time-consuming and labour-intensive and are usually unable to remove grease or oil residues sufficiently. Repeated abrasive cleaning can also impair existing surface structures and increase the risk of slipping on traffic surfaces.

### SUMMARY

The invention is based on the problem of providing a cleaning device with which any ground areas and in particular, traffic surfaces can be effectively and quickly cleaned of contaminants without risk of damage. Furthermore, an effective and cost-efficient cleaning method for cleaning the aforementioned ground areas is to be proposed.

To solve this problem, the invention proposes the following,
that the cleaning device is equipped with a cleaning vehicle which comprises several drive castor wheels in the area of a bottom of the vehicle, at least one of which is designed as a drive castor wheel, which can rotationally be driven by an electro-motor operated drive device located on board the cleaning vehicle in order to cause a vehicle movement of the cleaning vehicle across a ground area to be cleaned,
and that the cleaning device is equipped with a laser cleaning device which comprises a laser designed to generate laser radiation and a laser radiation output unit located on board the cleaning vehicle and following its vehicle movement,
wherein, during a cleaning operation of the laser cleaning device, the laser can generate laser radiation which exits at a laser radiation exit area of the laser radiation output unit and which can be directed in the area of the bottom of the vehicle to remove contaminants on an area of the ground area to be cleaned located below the cleaning vehicle,
wherein the cleaning device is equipped with a device for autonomous driving of the cleaning vehicle, which has a control system for autonomous driving of the cleaning vehicle and is connected to the control system of the cleaning vehicle
wherein the cleaning device is equipped with a device for autonomous vehicle movement of the cleaning vehicle, which contains control electronics located on board the cleaning vehicle and networked with the drive device and the vehicle sensor system of the cleaning vehicle.

The problem is further solved by a cleaning method, which is carried out using a cleaning device designed in the aforementioned manner, wherein the cleaning vehicle performs an autonomous vehicle movement over the ground area to be cleaned, so that the ground area is irradiated by the laser radiation exiting at the laser radiation exit area, when the laser is activated below the cleaning vehicle, thereby removing contaminants from the ground area.

The cleaning device enables mobile laser radiation cleaning of traffic surfaces and any other ground areas, which is characterised by time-saving application, high effectiveness and gentle treatment of the ground areas. The cleaning process takes place as the cleaning vehicle moves over the ground areas to be cleaned, wherein the laser radiation generated by the activated laser cleaning device, which is emitted by a laser radiation output unit designed as a part of the cleaning vehicle, hits the region of the ground area currently located under the cleaning vehicle and, through this irradiation, removes contaminants from the often also structured ground area. Existing contaminants such as layers of dirt, oil and grease stains or other persistent, localised residues of any kind can be gently removed by evaporation through the application of energy, without the need for mechanical means or additional cleaning aids. The cleaning process is therefore environmentally friendly and cost-effective. The intensity of the irradiation can be individually adjusted depending on the material of the ground area by selecting a suitable radiation energy and/or laser beam shape, either ex works or by means of an existing adjustment device, in order to achieve the best possible cleaning result. The laser can be designed to generate pulsed and/or continuous laser radiation, for example depending on the degree of contamination and the driving speed of the cleaning vehicle. Since the laser radiation output unit is located on board the cleaning vehicle and therefore always moves directly with the vehicle movement, a largely constant distance between the laser radiation exit area and the ground area to be cleaned can be ensured during cleaning runs, which guarantees consistent cleaning quality regardless of the operator's technical skills. The laser radiation output unit can be constantly aligned so that the emitted laser radiation always hits the ground area to be cleaned at a desired angle, enabling highly effective treatment that is gentle on the material. As the laser operates without media, contamination of the surroundings of the ground area to be cleaned by cleaning agents can also be avoided.

The cleaning device is equipped with a device for autonomous vehicle movement of the cleaning vehicle, which is hereinafter referred to simply as the ‘autonomous drive control device’.

In this way, depending on the degree of autonomy of the autonomous drive control device, the cleaning vehicle is able to drive across the ground area to be cleaned entirely without human intervention or at least largely automatically. The human monitoring effort is therefore very low or can be eliminated entirely, enabling very cost-effective yet reliable surface cleaning. Preferably, the autonomous drive control device is fully automated so that the cleaning vehicle can drive independently in all situations and no control by operating personnel is necessary or possible. However, an embodiment with a lower degree of automation is also possible, wherein there is nevertheless a high degree of automation in particular, in which the cleaning vehicle can drive autonomously in most situations, but the operating personnel have the option of intervening in unforeseen operating situations, for example via a remote control device. The driving commands forwarded to the drive device of the at least one drive castor wheel originate from control electronics located on board the cleaning vehicle, which communicate with vehicle sensor system located on board the cleaning vehicle and thus obtain the surrounding information required for autonomous driving.

It is preferable for the cleaning device to be equipped with a selection device that allows an operator to switch between autonomous driving mode and non-autonomous driving mode.

The ground area that can be cleaned using the cleaning device is, in particular, a traffic surface that can be walked on and/or driven on, although the cleanable ground areas may also be areas not used for traffic purposes, such as storage areas, marking areas, presentation areas or artistic areas. As a rule, the ground area to be cleaned is a floor area, but the cleaning device is also expediently suitable for cleaning flat roof areas, platform areas, stage areas or the like. The cleaning device can be used outdoors or in an interior space, for example to clean industrial floors.

Advantageous further developments of the invention are set out in the dependent claims.

Preferably, the cleaning device is designed in such a way that not only the vehicle movement of the cleaning vehicle but also the cleaning operation of the laser cleaning device can take place or does take place autonomously. For this purpose, the cleaning device is equipped with a device for autonomous cleaning operation of the laser cleaning device, which is functionally coordinated with the vehicle movement of the cleaning vehicle, which can also be generated autonomously, and which is hereinafter also referred to in simplified terms as the ‘autonomous cleaning control device’. The control electronics are preferably networked not only with the components required for autonomous driving mode, but also with the laser cleaning device. Advantageously, the degree of automation of the autonomous cleaning control device is, analogous to that of the autonomous drive control device, full automation or at least a high degree of automation, wherein preferably the same degree of automation as in the autonomous drive control device is present. It is useful if it is possible to make certain basic settings before starting operation, both for vehicle movement and for cleaning operation. For this purpose, the cleaning device is advantageously equipped with an input device.

In the cleaning method according to the invention, an expedient autonomous cleaning operation takes place during the autonomous vehicle movement of the cleaning vehicle. Preferably, the cleaning device is equipped in such a way that the cleaning operation can be performed either autonomously or non-autonomously.

Preferably, the device for autonomous cleaning operation is designed in such a way that the laser cleaning device is activated and deactivated selectively and independently during autonomous vehicle movement, for example, depending on obstacles located in the path of travel and detected by the vehicle sensor system and/or depending on the condition and/or degree of contamination of the area of the ground area to be cleaned that is currently being driven over or is about to be driven over. The intensity and/or direction of the laser radiation can also be autonomously adjustable based on the sensor-detected characteristics of the vehicle surrounding and/or the ground area.

Although it is possible to design them independently of each other, it is considered advantageous to combine the device for autonomous vehicle movement of the cleaning vehicle and the device for autonomous cleaning operation of the laser cleaning device into a single combined device for autonomous driving and cleaning operation. This minimises the manufacturing costs and the technical complexity of the sensor technology in particular.

It is advantageous if the device for autonomous cleaning operation of the laser cleaning device includes a switch actuator networked with the control electronics for alternately activating and deactivating the laser. The switch actuator is, for example, an electrically actuated linear actuator that can act on an operating control of the laser radiation output unit.

In order to enable fully automatic operation in particular, whether for controlling vehicle movement and/or cleaning operations, it is advantageous for the control electronics to be equipped with artificial intelligence (AI), hereinafter referred to as ‘AI’ for brevity.

The artificial intelligence (AI) used in the cleaning device preferably includes, among other things, data processing components, learning algorithms, decision-making components and interaction components. The data processing components are responsible for processing data that is required for training the AI and that is, for example, recorded by the vehicle sensor system during a training vehicle movement or entered in some other way in the form of reference data into a memory of the data processing components. The learning algorithms are responsible for training the AI and include, for example, algorithms for machine learning such as decision trees or artificial neural networks. The decision-making components are used for AI decision-making and analyse the input data provided during a vehicle movement, in particular by the vehicle sensor system and an optionally used satellite navigation system, and based on this, make decisions regarding, for example, the direction of travel and driving speed of the cleaning vehicle or the operating state of the laser cleaning device to be set. The interaction components are components through which the AI interacts with its surroundings and through which, in particular, the results determined by the AI are output. The interaction components include, for example, electrical interfaces at which the results of the AI are output in the form of electrical actuating currents for electrically actuable components of the cleaning vehicle, such as for the electrical drive device of the at least one drive castor wheel or for switching the laser on and off.

The vehicle sensor system is expediently designed to determine the position of the cleaning vehicle and/or to detect the condition or contamination of the ground area during vehicle movement, and usually comprises a plurality of sensors electrically connected to the control electronics, such as at least one ultrasonic sensor and/or at least one infrared sensor and/or at least one optoelectronic sensor and/or at least one radar sensor and/or at least one tactile impact sensor that responds to obstacles. The at least one optoelectronic sensor is preferably a laser-based sensor that is used in the cleaning vehicle to utilise the so-called LIDAR technology (‘Light detection and ranging’).

It is also advantageous if the vehicle sensor system includes at least one camera suitable for detecting the vehicle surroundings of the cleaning vehicle. Using one or more cameras, obstacles and/or the surface condition or the type and intensity of surface contamination can be detected with particular reliability and, for example, the route and/or laser cleaning can be individually adapted.

It is also advantageous if the vehicle sensor system networked with the control electronics comprises at least one sensor, referred to as a contamination sensor, which is capable of detecting the contamination on the ground area to be cleaned.

The vehicle sensor system also expediently includes sensor equipment for monitoring and/or providing feedback on the internal operating states of the cleaning vehicle, for example encoders for monitoring the rotational movement of at least one drive castor wheel.

Particularly high user comfort combined with high operating accuracy is achieved when the control electronics contain navigation electronics for a satellite navigation system, in particular for a GPS system (Global Positioning System). The satellite navigation system serves, for example, to determine the position and/or route of the cleaning vehicle on a map that can be evaluated by the navigation electronics, which has been previously stored in the control electronics, in particular in connection with a learning run or on the basis of existing mapping, or is constantly made available to the navigation electronics online, for example via a mobile phone system. A particularly high degree of positional accuracy can be achieved if the cleaning device comprises at least one base station installed in a fixed location during the vehicle movement of the cleaning vehicle, which provides an accurate positional reference point that can be compared by the navigation electronics with the data provided by the satellite navigation system.

It is preferable for the cleaning vehicle to be equipped with a handle that allows the vehicle to be moved manually in special situations if necessary. The handle is preferably used not only to steer the cleaning vehicle, but also to manually initiate a pushing and/or pulling driving force to generate the vehicle movement. In this way, the cleaning device can be operated without autonomous functionality and without motorised drive, especially for short-term use. Preferably, the handle can also be used in non-autonomous driving mode with simultaneous operation of the electro-motor operated drive device to guide the driven vehicle in the direction of travel. The handle also facilitates the transport of the cleaning vehicle and its desired placement at the place of use.

The optional handle is preferably designed as a folding handle. It can be folded down either into an upright operating position for its intended use or—for autonomous driving mode—into a non-obstructive, folded-down parking position.

The handle is expediently located in the area of the rear of the vehicle. The operator thus walks behind the cleaning vehicle and has a good view of the surrounding area to be cleaned at all times.

Easy handling of the cleaning vehicle is promised by a handle that is designed as a bow-shaped handle protruding from the vehicle chassis of the cleaning vehicle and comprises two upwardly protruding handle bars fixed to the vehicle chassis, between which a web-liked handling section extends, which can be grasped with the hands to guide and, if necessary, also to initiate a driving force.

In relation to a central vehicle longitudinal axis of the cleaning vehicle extending in one direction of travel, the handle may be asymmetrical in design so that the operator walking behind the cleaning vehicle can assume a position offset to the side of the cleaning vehicle. This facilitates cleaning work along walls or in safety areas, for example on railway platforms, which may not be entered. A comparable effect can be achieved with a handle that can be rotated at least in sections and can be fixed in either a symmetrical or asymmetrical working position.

The handle expediently has at least one manually operable manual actuation element that allows easy manual activation and deactivation of the laser. The manual actuation element, which is, for example, a hand lever, is part of a manual actuation device that is expediently mechanically coupled to the laser radiation output unit via a coupling device, so that the operating state of the laser can be influenced by acting on the laser radiation output unit. The coupling device can comprise, for example, a linkage and/or a Bowden cable.

A particularly cost-effective embodiment of the cleaning device is possible if the laser radiation output unit is designed as a compact laser pistol, which comprises a pistol main section with the laser radiation exit area and a pistol handle protruding transversely from the pistol main section. The pistol handle is assigned an operating control suitable for activating and deactivating the laser, which can be operated by selectively pressing or releasing it, comparable to the trigger of a firearm pistol.

When equipped with a laser pistol, the coupling device of the manual actuation device can advantageously be designed in such a way that it interacts with the operating control, which in principle can also be operated directly by hand, and in this way, the operating control can be operated remotely via the manual actuation element, even if the operating control is located in the cleaning vehicle in a place that is difficult or impossible to access.

The cleaning vehicle is particularly manoeuvrable if the castor wheels are designed partly as swivel castor wheels and partly as non-swivelling fixed castor wheels. Preferably, there are a total of four castor wheels, two of which are designed as fixed castor wheels and two as swivel castor wheels. Expediently, the fixed castor wheels and the swivel castor wheels are spaced apart from each other in the axial direction of a central vehicle longitudinal axis extending in the direction of travel of the cleaning vehicle. In this case, the fixed castor wheels and the swivel castor wheels are each arranged in pairs at the same axial height, wherein the axial height refers to the position in the axial direction of the vehicle longitudinal axis. At least one, and preferably each of the existing fixed castor wheels, is designed as a drive castor wheel to which the electro-motor operated drive device is coupled for drive purposes. Preferably, there are at least two drive castor wheels which can be driven by the drive device at different rotational speeds and/or which can be driven either in the same or in opposite directions of rotation, thereby enabling the cleaning vehicle to change direction or steer in a very confined space. Expediently, the drive device contains a separate, individually controllable electric drive motor for each drive castor wheel.

It is considered advantageous if the cleaning vehicle comprises a laser radiation shielding device which shields at least the laser radiation exit area and thus also the laser radiation emitted there from the surroundings, with the exception of an area on the bottom of the vehicle which, when the cleaning vehicle is used as intended, faces downwards and allows the laser radiation to exit in order to perform a cleaning process.

The laser radiation shielding device expediently comprises a shielding housing which encloses a working chamber in an opaque manner and thus without any possibility of laser radiation escaping, wherein the laser radiation exit area is located within this working chamber. To enable cleaning measures, the shielding housing comprises a working opening that points exclusively downwards during a cleaning process in accordance with its intended use and faces the ground area to be cleaned, through which the laser radiation exiting within the working chamber at the laser radiation exit area can irradiate the ground area without damaging the immediate or wider surroundings.

The best possible safety without compromising cleaning effectiveness is provided by an advantageous embodiment in which the window is surrounded by a downwardly projecting, sleeve-shaped protective wall, which is at least partially and preferably entirely flexible and which, when the cleaning vehicle is used as intended, can rest against the ground area to be cleaned with its lower peripheral area, so that it can slide over the ground area while maintaining constant surface contact during vehicle movement. The flexibility enables automatic adaptation to the individual surface structures of the ground area and allows the flexible protective wall to make shielding contact with the ground area in both raised and recessed surface areas. A particularly good protective result can be achieved with a flexible protective wall whose flexibility consists of a brush structure. For example, a natural or synthetic textile material is used to create the brush structure.

It is preferable for the entire laser radiation output unit to be encapsulated in the working chamber and shielded from the surroundings.

For example, in order to facilitate maintenance work, but also to enable thorough internal cleaning of the cleaning vehicle if necessary, it is advantageous if the shielding housing comprises a cover that can be removed to access the working chamber, for example by completely removing it or by opening it up.

Lasers are generally classified into different laser classes according to their hazard potential. Class 1 lasers have the lowest hazard potential. In class 4 lasers, the accessible laser radiation is extremely dangerous due to its high intensity. For effective cleaning of the ground area, a laser belonging to class 4 in terms of intensity is recommended. In order for such a class 4 laser to be used without restriction even in the often heavily frequented regions surrounding the ground area to be cleaned, it is advantageous if the laser cleaning device is equipped with a class 4 laser, but the laser radiation shielding device is designed in such a way that, due to the shielding measures taken, the laser cleaning device is only classified as the unproblematic laser class 1.

The laser radiation output unit expediently comprises a laser optic arranged upstream of the laser radiation exit area in the opposite direction to the radiation direction. With the aid of the laser optic, the shape and direction of the emitted laser radiation can be influenced and specified in particular.

For the sake of high stability, the cleaning vehicle is expediently equipped with a vehicle chassis on which both the castor wheels and the laser radiation output unit are mounted. The handle is also expediently attached to the vehicle chassis.

It is advantageous if the cleaning vehicle comprises a positioning device that allows the laser radiation output unit to be variably adjusted to a working position.

Particularly when a very high-power laser is used, it is expedient, due to the associated size, to design the laser as a separate part of the transportable cleaning device with respect to the cleaning vehicle. The laser can, for example, be designed as a portable stand-alone device or as a mobile device with its own castor wheels, so that it can be positioned away from the cleaning vehicle as required, wherein it is connected to the cleaning vehicle via a flexible line assembly for transmitting the laser light, so that the latter comprises a high degree of freedom of movement.

In the case of a laser with lower power or smaller dimensions and/or if the cleaning application also tolerates larger dimensions of the cleaning vehicle, the laser can be arranged together with the laser radiation output unit on board the cleaning vehicle so that both components of the laser cleaning device follow the vehicle movement of the cleaning vehicle.

It is preferable for the laser cleaning device to be additionally equipped with a suction device that enables the suction cleaning of ablation media produced during a cleaning process. Since the ablation media are at least predominantly gaseous in consistency, suction cleaning can effectively prevent pollution of the surroundings.

The suction device has a suction opening conveniently located in the area of the laser radiation output unit, which communicates with a suction power unit of the suction device and which, if a laser radiation shielding device is present, is conveniently located inside the working chamber. The suction power unit may be equipped with a filtering device and comprise a receiving space in which extracted particles are collected for later disposal.

In order to provide the electrical energy required to operate in particular, the electro-motor operated drive device, the control electronics, the vehicle sensor system and the laser cleaning device, the transportable cleaning device is expediently equipped with a suitable power source. The power source is, for example, an accumulator as a power storage device and/or a power generator. Depending on the embodiment of the transportable cleaning device, the power source can be located directly on board the cleaning vehicle or designed as a component independent of it. For example, the laser and the power source can be designed as independent entities independent of the cleaning vehicle.

To prevent injuries or damage due to improper use, it is advantageous if the cleaning vehicle comprises a safety device that prevents the laser from being activated under certain usage situations.

It is advantageous to equip the safety device with a ground detection device that prevents the laser from being activated when the cleaning vehicle is raised and its castor wheels are no longer resting on the ground. The ground detection device is designed in particular to detect a position of use of the cleaning vehicle with its castor wheels standing on the ground and a position of non-use of the cleaning vehicle with its castor wheels not standing on the ground. As long as the position of non-use is detected, the laser is expediently placed in a blocking state that prevents its activation. When the position of use is detected, the laser can be set to a standby state that allows its activation and is also set to this state, provided that the safety device does not contain any further safety components that prevent the standby state from being activated.

As a further safety component, the safety device may, for example, comprise a cover detection device in connection with a laser radiation shielding device having a cover, which is capable of detecting a closed state of the cover closing the working chamber and an open state of the cover making the working chamber accessible. As long as the open state is detected, the laser remains in a blocking state that prevents its activation. If the closed state is detected, the laser can be put into a standby state that allows its activation. If the cover detection device is combined with a ground detection device, it is expediently to have a signal-technical connection such that the laser is only put into the standby state when both the position of non-use of the cleaning vehicle and the closed state of the cover are currently detected.

In a preferred embodiment, the aforementioned ground detection device has a sensing wheel that is movable relative to the castor wheels in the height direction of the cleaning vehicle, which is provided for sensing the ground beneath the cleaning vehicle and which is constantly preloaded into a lowered locking state that protrudes downwards beyond the castor wheels, for example by a weight force and/or by a spring device. Through contact with the ground, the sensing wheel can be pushed up into an unlock position, wherein the unlock position causes the laser to be in a standby state and the locking state causes the laser to be in a blocking state. The setting is made in such a way that the sensing wheel is positioned in the unlock position at least substantially at the same height as the castor wheels, in other words, the sensing wheel and the castor wheels rest equally on the ground.

A preferred location for the sensing wheel is in the proximity of the laser radiation exit area, in particular transversely to the direction of travel next to the laser radiation exit area.

### BRIEF DESCRIPTION OF THE DRAWINGS

The terms Fig., Figs., Figure, and Figures are used interchangeably in the specification to refer to the corresponding figures in the drawings.

The invention is explained in more detail below with reference to the accompanying drawing. This shows:

FIG. 1 a preferred embodiment of the transportable cleaning device according to the invention in a side view, wherein the laser is designed as part of an entity separate from a cleaning vehicle, which is connected to the cleaning vehicle via line connections indicated by dashed lines, wherein both the cleaning vehicle and the entity are placed on a ground comprising the ground area to be cleaned, and wherein the components for autonomous operation are predominantly only indicated schematically,

FIG. 2 the arrangement from FIG. 1 in a top view according to arrow II from FIG. 1, wherein the dotted line indicates an optional feature of the cleaning vehicle with the laser,

FIG. 3 a longitudinal section through the cleaning vehicle according to sectional plane III-III from FIG. 2, wherein the laser radiation output unit is only indicated by a dashed line and line connections extending from the top are also not shown, and

FIG. 4 a longitudinal section through the cleaning vehicle according to sectional plane IV-IV in the area of a ground detection device, wherein a movable sensing unit equipped with a sensing wheel is illustrated in solid lines in an unlock position and in dotted lines in a correspondingly lowered locking state.

### DETAILED DESCRIPTION

The drawing shows a in particular transportable cleaning device with reference number 1, which is of preferred construction and serves to clean, any ground area 2 accessible from above.

The ground area 2 to be cleaned faces upwards in particular, wherein it may be aligned horizontally or diagonally in its entirety or in sections.

The ground area 2 that can be cleaned using the cleaning device 1 is, for example, a traffic surface 3 that can be walked on and/or driven on, although the ground area 2 that can be cleaned according to the invention may also be an area not used for traffic purposes, such as a storage area, marking area, presentation area or artistic area. As a rule, the ground area 2 to be cleaned is a floor area, but the cleaning device 1 is also suitable for cleaning non-floor areas such as flat roof areas, platform areas, stage areas or the like. The cleaning device 1 can be used outdoors or in an interior space, for example for cleaning industrial floors.

The ground area 2 that can be cleaned using the cleaning device 1 can, in principle, be of any type; for example, it can be a foundation surface 2a, such as a concrete surface or a screed surface, or a covering surface 2b, such as an asphalt surface, a paved surface, a tiled surface, a laminate surface, and so on. The drawing shows several paving stones 6 as an example, which define a paved surface 2b to be cleaned and are laid adjacent to a foundation surface 2a that is also to be cleaned, wherein the paved surface 2b and the foundation surface 2a represent a ground area to be cleaned.

Over time, the ground area 2, which is exposed to the weather and other external influences, can sometimes become significantly soiled, so that cleaning is desirable from time to time. The cleaning device 1 is designed to perform such cleaning.

The cleaning device 1 comprises a cleaning vehicle 8, which can be used to perform mobile laser radiation cleaning of the ground area 2. During its intended use, the cleaning vehicle 8 assumes a position of use as shown in the drawing, in which it stands on a ground 11 formed by the ground area 2, and can be moved on this ground 11 and thus also over the ground area 2 by performing a vehicle movement 12 indicated by an arrow. As mentioned above, the ground area 2 is formed, for example, by the foundation surface 2a and the covering surface 2b.

The cleaning vehicle 8 has a central vehicle longitudinal axis 13 defining a longitudinal direction of the vehicle 13a, wherein the vehicle movement 12 takes place mainly in a forward direction of travel 12a coinciding with the longitudinal direction of the vehicle 13a, but can also take place in an opposite reverse direction of travel 12b. The cleaning vehicle 8 also has a vehicle transverse axis 14 orthogonal to the vehicle longitudinal axis 13 and a vehicle high axis 15 orthogonal to the vehicle longitudinal axis 13 and the vehicle transverse axis 14, which is usually aligned at least substantially vertically when the cleaning vehicle 8 is in use.

The cleaning vehicle 8 has a front of the vehicle 16a oriented in the longitudinal direction 13a of the vehicle, a rear of the vehicle 16b opposite to this, a bottom of the vehicle 16c facing the ground 11 in the position of use, and a top of the vehicle 16d facing upwards and opposite the bottom of the vehicle 16c.

The cleaning vehicle 8 is equipped with several castor wheels 17, with which it stands mobile on the ground 11 in the position of use and which roll on the ground 11 when a vehicle movement 12 is performed. The vehicle movement 12 is possible both as forward travel in the forward direction of travel 12a and as reverse travel in the reverse direction of travel 12b.

At least one of the castor wheels 17 is designed as a rotationally driven castor wheel and is therefore referred to as a drive castor wheel 19. This applies, for example, to two castor wheels 17 arranged next to each other at a distance in the vehicle transverse direction 14a. These two drive castor wheels 19 are coupled to an electro-motor operated drive device 9 of the cleaning vehicle 8, wherein the drive device 9 can drive each of the two drive castor wheels 19 either clockwise or anticlockwise. In this way, forward or reverse motion can be generated by the electro-motor.

The two drive castor wheels 19 can be driven by the drive device 9 at equal and different rotational speeds and in equal and opposite directions of rotation. In this way, the cleaning vehicle 8 can achieve different driving speeds and can change direction or steer in confined spaces in order to follow a desired route.

Expediently, the drive device 9 comprises a separate, individually controllable electric drive motor 9a, 9b for each drive castor wheel 19.

The cleaning vehicle 8 preferably has four castor wheels 17, two of which are designed as fixed castor wheels 17a and two as swivel castor wheels 17b in the embodiment. The two fixed castor wheels 17a are examples of the drive castor wheels 19. The cleaning vehicle 8 expediently has a vehicle chassis 18 on which the castor wheels 17 are rotatably arranged by means of suitable suspension measures. For example, the two fixed castor wheels 17a are located in the area of the front of the vehicle 16a and the two swivel castor wheels 17b are located in the area of the rear of the vehicle 16b. The fixed castor wheels 17a and the swivel castor wheels 17b are thus arranged at a distance from each other in the longitudinal direction 13a of the vehicle. Both the two fixed castor wheels 17a and the two swivel castor wheels 17b are expediently located at the same height in the longitudinal direction 13a of the vehicle and, in particular, at the same distance on opposite sides of the vehicle longitudinal axis 13 extending through the centre of the vehicle.

The swivel castor wheels 17b can each be rotated relative to the vehicle chassis 18 about an axis of rotation 21 parallel to the vehicle high axis 15 in order to passively enable a steering movement of the cleaning vehicle 8 caused by a coordinated drive rotation of the two drive castor wheels 19. Each swivel castor wheel 17b is expediently equipped with a parking brake 20 for fixing the cleaning vehicle 8 in place at the desired location on the ground 11.

The fixed castor wheels 17a cannot be swivelled. They can only roll around an axis of rotation 22a parallel to the vehicle transverse axis 14, which is defined by a drive shaft 22 of the drive device 9.

It goes without saying that the castor wheels 17 may also be present in a different number and in a different distribution pattern. For example, the cleaning vehicle 8 could be designed with three wheels, in particular with two fixed castor wheels 17a as drive castor wheels 19 and only one swivel castor wheel 17b.

For example, cleaning vehicle 8 comprises a handle 23 attached to the vehicle chassis 18 in the area of the rear of the vehicle 16b, which can be grasped by an operator to manually initiate a pushing and/or pulling driving force with their hands. The handle 23 can also be used to guide the cleaning vehicle 8, i.e. in particular to specify the direction of vehicle movement 12. In principle, the cleaning vehicle 8 is designed for motorised propulsion by means of the drive device 9. The optional handle 23 is intended for cases in which motorised propulsion is not desired, in particular for transport between different locations or for easier repositioning at a location. However, the handle 23 can in principle also be used for steering purposes with motorised propulsion.

Preferably, the handle 23 is located in the area of the rear of the vehicle 16b so that it can be easily grasped by an operator standing behind the cleaning vehicle 8 and pushed forward by this operator.

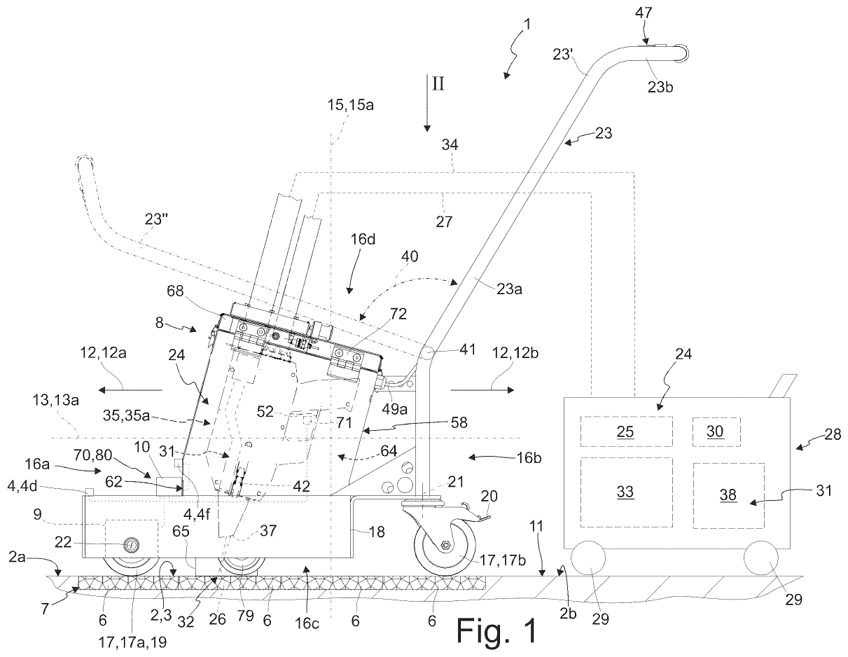

The optional handle 23 is preferably designed as a folding handle. It can be folded down according to the double arrow 40 around a joint mechanism 41, illustrated only in FIG. 1, either into an upright operating position 23′ shown in solid lines for its intended use, or, when not in use, into a parking position 23″ indicated by dotted lines in FIG. 1, folded down towards the vehicle chassis 15.

For example, handle 23 is a bow-shaped handle extending upwards from the lower vehicle chassis 18, which comprises two handle bars 23a, in particular in the form of holms, spaced apart from each other in the axial direction of the vehicle transverse axis 14, referred to as the vehicle transverse direction 14a, which are each attached to the vehicle chassis 18 at a lower end region and are connected to each other at their upper end region by a horizontal web-like handling section 23b. The handling section 23b is used to grip with the hands for the purpose of guiding the cleaning vehicle 8.

For example, handle 23 is symmetrically designed with respect to a center plane 39 spanning the central vehicle longitudinal axis 13 and the vehicle high axis 15. However, deviating from this, it can be designed asymmetrically with respect to the vehicle longitudinal axis 13 of the vehicle or, more precisely, with respect to the aforementioned center plane 39, as indicated by the dotted lines at 23, 23c. This allows the cleaning vehicle 8 to be conveniently guided in a position offset in the vehicle transverse direction 14a of the vehicle relative to the operator. Alternatively, the handle 23 could be rotatable in the vehicle transverse direction 14a at least in a grip section comprising the handling section 23b, in order to position it in different transverse positions. These transverse positions can be releasably locked in particular by means of a locking device of the cleaning vehicle 8.

The cleaning device 1 is equipped with a laser cleaning device 24, which is designed to irradiate and thus treat the ground area 2 with laser radiation 26 generated by a laser 25 belonging to the laser cleaning device 24 in order to remove contaminants. Due to the laser radiation treatment, this involves in particular the thermal removal of contaminants, in particular in that the contaminants are at least predominantly vaporised by the energy of the laser radiation 26.

Laser radiation cleaning takes place during a vehicle movement 12 of the cleaning vehicle 8, which can also be referred to as a cleaning run, over the ground area 2 to be cleaned, which is carried out when the laser 25 is activated. The laser 25 can be set to either an activated or deactivated operating state, wherein laser radiation 26 is generated in the activated operating state and no laser radiation is generated in the deactivated operating state.

In the illustrated embodiment, the operating state of the laser 25 can be specified both manually by a person operating the cleaning device 1 and by a device 70 integrated into the cleaning vehicle 8 for autonomous cleaning operation of the laser cleaning device 24, which is also referred to below as the autonomous cleaning control device 70 for the sake of simplicity. Unillustrated embodiments of the cleaning device 1 each have only one of these two operating options.

The autonomous cleaning control device 70 has control electronics 10 located on board the cleaning vehicle 8, which are designed in particular as an electronic unit or consist of decentralised electronic components. Among other things, the control electronics 10 implement control software for vehicle functions.

Der Laser 25 kann gemäß einer in Figur 2 strichpunktierten Illustration ein fester Bestandteil des Reinigungsfahrzeuges 8 sein und dessen Fahrbewegung 12 mitmachen. Gemäß dem in durchgezogenen Linien dargestellten bevorzugten Ausführungsbeispiel ist der Laser 25 jedoch gesondert bezüglich des Reinigungsfahrzeuges 8 ausgebildet, was die Möglichkeit bietet, einen Laser 25 hoher Leistung und entsprechend größeren Abmessungen zu verwenden, ohne die Wendigkeit des Reinigungsfahrzeuges 8 zu beeinträchtigen. Der als Stand-Alone-Gerät ausgebildete Laser 25 ist über eine flexible Leitungsanordnung 27 mit dem Reinigungsfahrzeug 8 verbunden, wobei die flexible Leitungsanordnung 27 unter anderem dafür vorgesehen ist, die vom Laser 25 erzeugte Laserstrahlung zur bestimmungsgemäßen Verwendung an das Reinigungsfahrzeug 8 zu übermitteln.

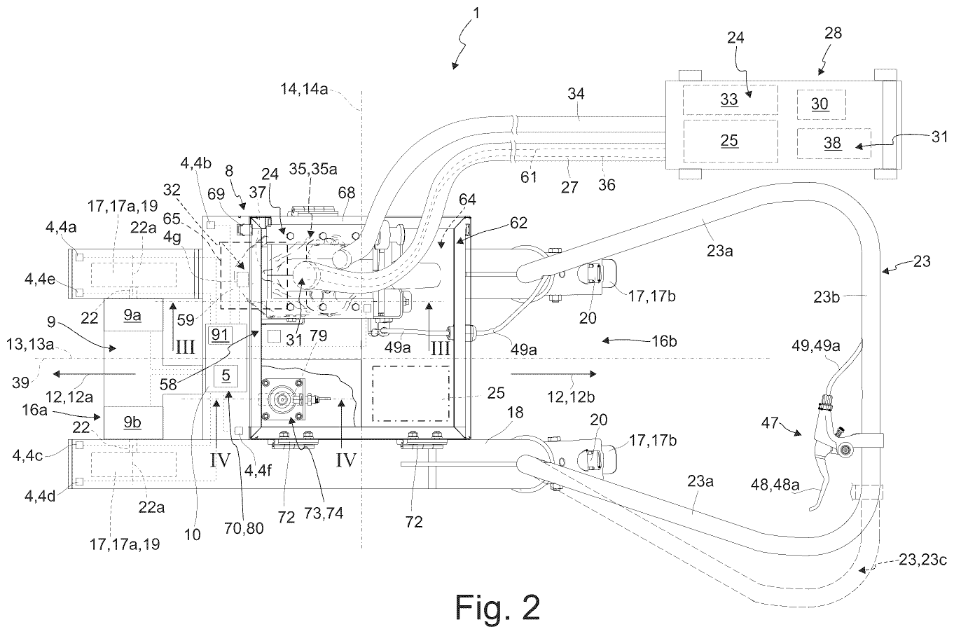

The laser 25 may be an integral part of the cleaning vehicle 8, as shown in the dotted illustration in FIG. 2, and may follow its vehicle movement 12. However, according to the preferred embodiment shown in solid lines, the laser 25 is designed separately from the cleaning vehicle 8, which offers the possibility of using a high-power laser 25 with correspondingly larger dimensions without impairing the manoeuvrability of the cleaning vehicle 8. The laser 25, which is designed as a stand-alone device, is connected to the cleaning vehicle 8 via a flexible line assembly 27, wherein the flexible line assembly 27 is intended, among other things, to forward the laser radiation generated by the laser 25 to the cleaning vehicle 8 for its intended use.

The laser 25, which is designed separately for the cleaning vehicle 8, is preferably part of a structural unit referred to below as a transportable entity 28, which is placed at a distance from the cleaning vehicle 8 during use of the cleaning vehicle 8, wherein a flexible line assembly 27 of sufficient length ensures a sufficient radius of movement for the cleaning vehicle 8.

The entity 28 can be equipped with wheels 29 so that it can be conveniently moved along with the cleaning vehicle 8 from time to time. The entity 28 is designed in particular as a mobile entity 28 which, like the cleaning vehicle 8 and at the same time independently of the cleaning vehicle 8, can be moved on the ground 11.

In a simple configuration of the cleaning device 1, the entity 28 contains only the laser 25 and any components that may be required to control it, in particular an electronic laser control device 30.

It is advantageous if the laser cleaning device 24 is equipped with a suction device 31, through which media referred to as ablation media, which are produced during a cleaning process in the working area 32 of the laser radiation 26, can be extracted in order to avoid contamination of the surroundings, in particular dust and odour contamination. The laser cleaning device 24 comprises such a suction device 31 as an example.

The suction device 31 contains an electrically operated suction power unit 33 for generating the desired suction effect, which is expediently designed as a further part of the entity 28. A flexible suction pipe 34 establishes a connection between the suction power unit 33 and the cleaning vehicle 8. It is designed separately from the flexible line assembly 27, but can also be an integral part of this flexible line assembly 27.

Depending on the size of the cleaning vehicle 8, the suction power unit 33 can alternatively also be a direct part of the cleaning vehicle 8.

The laser radiation 26 for treating the ground area 2 is emitted by a laser radiation output unit 35 located on board the cleaning vehicle 8 and therefore always moving with the vehicle 12, as shown in the drawing by the dotted line, which is a further part of the laser cleaning device 24. The flexible line assembly 27 connects the laser 25 to the laser radiation output unit 35 and contains at least one optical connecting line 36 for transmitting the laser light, which is preferably designed as a fibre optic cable.

The laser radiation output unit 35 has a laser radiation exit area 37, which is arranged in the area of the bottom of the vehicle 16c and allows the laser radiation 26 that can be generated or is generated by the laser 25 to exit. The laser radiation exit area 37 is aligned in the position of use of the cleaning vehicle 8 so that it faces the ground 11 located beneath the cleaning vehicle 8. The above-mentioned working area 32 is the area in which the laser radiation 26 exiting the laser radiation exit area 37 hits the ground area 2 to be cleaned.

In order to provide the electrical energy required to operate the electro-motor operated drive device 9 and the laser 25, the cleaning device 1 is expediently equipped with a suitable power source 38. This power source 38 is, for example, a rechargeable accumulator for storing electricity or a power generator, such as a diesel generator. An accumulator and a power generator can also be combined to enable longer-lasting off-grid operation.

The power source 38 also expediently supplies the electrical energy for operating the suction device 31.

The laser radiation output unit 35 preferably comprises a schematically indicated laser optic 42, which is responsible in particular for the radiation geometry of the laser radiation 26 exiting at the laser radiation exit area 37 and ensures, for example, that the laser radiation 26 hits the ground area 2 to be cleaned in a point-shaped or line-shaped manner. The laser optic 42 is located within the laser radiation output unit 35 and is positioned upstream of the laser radiation exit area 37 in the opposite direction to the radiation direction.

Preferably, the laser radiation output unit 35 is attached directly or indirectly to the preferably existing vehicle chassis 18 in any manner. Consequently, the laser radiation output unit 35 is supported by the vehicle chassis 18, which ensures high structural stability of the cleaning vehicle 8. A fastening device 43 used to fasten the laser radiation output unit 35 comprises, for example, a fixing bracket 45 into which the laser radiation output unit 35 is at least partially inserted.

It is advantageous if the fastening device 43 allows variable positioning of the laser radiation output unit 35 relative to the castor wheels 17 and, accordingly, also relative to the optional vehicle chassis 18. This advantage applies, for example, because the fastening device 43 is designed here as a positioning device 44 that allows the aforementioned positioning. This design results, for example, from the fact that the fixing bracket 45 is connected to the vehicle chassis 18 by means of fastening screws 46 and can be moved and/or pivoted relative to the vehicle chassis 18 when the fastening screws 46 are loosened. This offers the advantageous possibility of positioning the laser radiation exit area 37 at different height positions and/or in different angular orientations.

The positioning device 44 can be electro-motor operated in a manner not illustrated for autonomous cleaning operation of the laser cleaning device 24 and can be designed as a part of the autonomous cleaning control device 70. In this case, it is connected to the control electronics 10 for operation as required. This results in a motor-controlled laser cleaning device 24 that is capable of executing the movements specified by the control electronics 10 as optimized with regard to the laser radiation 26.

The cleaning vehicle 8 is expediently equipped with a manual actuation device 47, which allows convenient manual activation and deactivation of the laser 25 by the operator driving the cleaning vehicle 8. This applies in cases where autonomous cleaning operation is not desired.

The manual actuation device 47 comprises a manually operable manual actuation element 48 arranged on the handle 23, which is mechanically coupled to the laser radiation output unit 35 via a coupling device 49 and which can be used to trigger an operating process on the laser radiation output unit 35, whereby the laser 25 can be activated or deactivated.

For example, the manual actuation element 48 is a hand lever 48a that can be operated with one hand and is connected via a Bowden cable 49a of the coupling device 49 to a movable operating control 52 of the laser radiation output unit 35. By selectively pulling or releasing the hand lever 48a, the operating control 52 can be actuated and, accordingly, the laser 25 can be switched on and off.

In a non-illustrated embodiment, a bow-shaped manual actuation element 48 extending parallel to the handling section 23b is pivotably attached to the upper end region of the handle 23 and is coupled to the operating control 52 via a Bowden cable 49a.

Instead of the Bowden cable 49a, a linkage could also be provided, for example.

In any case, the manual actuation device 47 enables convenient remote actuation of the operating control 52 arranged on the laser radiation output unit 35.

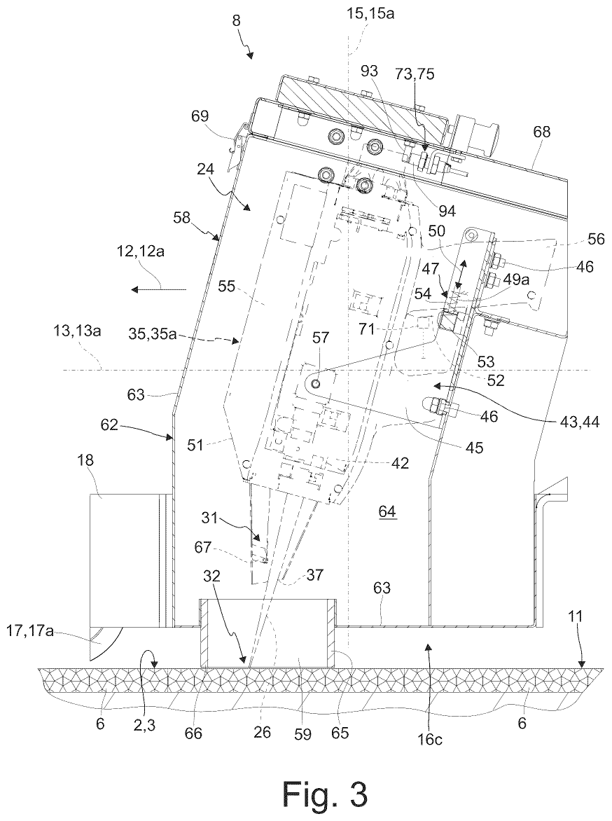

The laser radiation output unit 35 has, for example, an housing referred to below as the output unit housing 51, from which the operating control 52 protrudes. This operating control 52 can be operated by selectively pressing or releasing it, wherein it activates the laser 25 when pressed and deactivates it when not pressed. The coupling device 49 has an actuating element 53 adjacent to the operating control 52, which is attached, for example, to the Bowden cable 49a and is biased by a spring device 54 into an unactuated state in which the operating control 52 is not subjected to any pressing force. By actuating the manual actuation element 48, the actuating element 53 can also be switched to an actuated state, in which it holds the operating control 52 pressed. The switch movement 50 of the actuating element 53 that takes place here is illustrated in FIG. 3 by a double arrow.

In an embodiment not illustrated, the operating control 52 is arranged inside the output unit housing 51 and the coupling device 49 extends into the output unit housing 51.

The autonomous cleaning control device 70 expediently has an electrically actuated actuator 71 networked with the control electronics 10 for alternatively activating and deactivating the laser 25, which is referred to as the switch actuator 71 for better differentiation. The switch actuator 71 cooperates, for example, in parallel with the actuating element 53 with the operating control 52, which can therefore be actuated both manually via the manual actuation element 48 and automatically via the switch actuator 71. The connection is indicated by a dotted line.

The laser radiation output unit 35 is designed, for example, as a laser pistol 35a, which comprises an elongated pistol main section 55 and a pistol handle 56 extending transversely from the pistol main section 55. The operating control 52 is located in the area of the pistol handle 56. The laser pistol 35a is fixed to the fixing bracket 45 in the area of the pistol main section 55, among other places. An associated fixing area 57 can cause the laser pistol 35a to be pivotally mounted about an axis of rotation parallel to the vehicle transverse axis 14 in order to easily perform the above-mentioned adjustment measure by means of the positioning device 44.

Preferably, the cleaning vehicle 8 comprises an overall laser radiation shielding device designated by reference numeral 58, which prevents hazardous laser radiation 26 from escaping from the cleaning vehicle 8 in a manner that could endanger persons. The laser radiation shielding device 58 shields the laser radiation exit area 37 all around, with the exception of an area located on the bottom of the vehicle 16c, in which there is a window 59 through which the laser radiation 26 can exit to irradiate the ground area 2.

For example, the laser radiation shielding device 58 comprises a shielding housing 62 which has a housing wall 63 that is opaque at least in the vicinity of the laser radiation exit area 37. The housing wall 63 encloses a housing chamber designated as the working chamber 64, in which the laser radiation exit area 37 is located. For example, the entire laser radiation output unit 35 is preferably accommodated in the working chamber 64 and fixed to the inside of the housing wall 63 via the fastening device 43, which is attached to the vehicle chassis 18 or forms part of the vehicle chassis 18.

The housing wall 63 encloses the working chamber 64, in particular at the top 16d of the vehicle and also all around at the front, rear and sides. The working chamber 64 is also largely confined by the housing wall 63 at the bottom 16c of the vehicle, wherein only an area defining the window 53 is open.

The window 59 is preferably positioned so that it is as close as possible to the ground 11 during a cleaning run. This ensures that the reflected laser radiation 26 is reflected back into the working chamber 64 and is not emitted into the surroundings of the cleaning vehicle 8.

The exemplary cleaning vehicle 8 has an embodiment that allows the window 59 to be located practically directly on the ground area 2 to be cleaned. This is achieved by the housing wall 63 in the area of the window 59 being framed by a downwardly projecting sleeve-shaped protective wall 65, which has at least partially flexible properties and projects downward in an axial direction of the vehicle high axis 15, referred to as the vehicle height direction 15a. A lower annular peripheral area 66 of the protective wall 65 is arranged at such a height level relative to the castor wheels 17 that, in the position of use of the cleaning vehicle 8, it rests against the ground 11 beneath the cleaning vehicle 8 and thus against the region of the ground area 2 currently located there. During the vehicle movement 12, the protective wall 65 can slide over the ground area 2 with its peripheral area 66 due to its flexibility, while maintaining contact with the ground area 2. In this way, unwanted escape of laser radiation 26 can be reliably prevented.

The protective wall 65 is expediently designed to be flexible, at least in the lower peripheral area 66. For example, it is designed as a flexible protective wall 65 overall. The flexibility results in particular from an embodiment as an opaque brush structure.

The at least partially flexible protective wall 65 is equipped in particular in such a way that, when the cleaning vehicle 8 is not parked on a ground 11, it protrudes beyond a plane that can be designated as the contact plane, which is determined by the contact surfaces of the castor wheels 17 with which the castor wheels 17 are placed on the ground 11 in the position of use of the cleaning vehicle 8. In the position of use of the cleaning vehicle 8, the protective wall 65 is therefore pressed slightly upwards and rests on the ground 11 with a certain amount of preload, wherein it adopts the surface structure of the ground 11 in the contact area.

The sleeve-shaped protective wall 65 preferably comprises a rectangular and, in particular, square cross-sectional contour, but in principle it can also be round and, in particular, circular in contour.

In order to be able to remove even strongly adhering contaminants from the ground area 2, the laser 25 has a high intensity, in particular in that the laser 25 falls into laser class 4. However, due to the encapsulation described above by means of the laser radiation shielding device 58, the laser cleaning device 24 as a whole is classified as laser class 1 in terms of its operational status. In this way, cleaning runs can be performed with high laser energy and correspondingly high thoroughness without having to take into account the fact that cleaning runs are performed on public traffic surfaces 3 and, under certain circumstances, in areas heavily frequented by people.

The extraction performed by means of the suction device 31 takes place at at least one suction opening 67 of the cleaning vehicle 8, which communicates with the suction pipe 34. The suction opening 67 is expediently located inside the working chamber 64 and preferably inside the laser radiation output unit 35. During operation of the suction power unit 33, a suction flow is formed between the suction opening 67 and the suction power unit 33, through which the removal media produced during laser cleaning are reliably extracted.

The cleaning device 1 is equipped with a device 80 for autonomous generation of the vehicle movement 12 of the cleaning vehicle 8, which is hereinafter referred to as the autonomous drive control device 80 for the sake of simplicity.

A part of the autonomous drive control device 80 is the control electronics 10 already mentioned in connection with the autonomous cleaning control device 70, which is networked with components of both control devices 70, 80, as indicated by dotted lines. The control electronics 10 expediently belong to both autonomous control devices 70, 80. Specifically, a preferred implementation is one in which the autonomous drive control device 80 and the autonomous cleaning control device 70 are combined in a single combined device for autonomous driving and cleaning operation 70, 80. In principle, however, it is also possible to design the two autonomous control devices 70, 80 independently of each other. Furthermore, it is possible to dispense with equipping the cleaning device 1 with an autonomous cleaning control device 70, in particular if it is to be expected that the cleaning tasks to be performed will generally always be carried out under constant surface conditions.

The autonomous drive control device 80 enables the cleaning vehicle 8 to move across the ground area 2 to be cleaned entirely without human intervention or at least largely automatically, depending on the degree of autonomy achieved. The autonomous vehicle movement 12 results from electrical driving commands that the control electronics 10 forward to the drive device 9 for the drive castor wheels 19, which is electrically connected to it.

The autonomous drive control device 80 is preferably designed with a full automation autonomy level, but in particular with at least a high automation autonomy level. In full automation mode, the cleaning vehicle 8 can drive autonomously in all situations and does not require any control by operating personnel. In the case of high automation, the cleaning vehicle 1 can drive predominantly autonomously, wherein the operating personnel have the option of intervening in unforeseen operating situations. For such intervention measures, the cleaning device is expediently equipped with a remote control device, which is not illustrated in detail and which operates in particular on a wireless radio basis.

The electrical driving commands issued by the control electronics 10 on board the cleaning vehicle 8 to the drive unit 9 are generated on the basis of electrical information supplied by the vehicle sensor system 4 located on board the cleaning vehicle 8 and networked with the control electronics 10, which information is in particular surrounding and/or positional information. The networking is indicated by dotted lines.

In this way, the cleaning vehicle 8 can be given a route to follow along the ground area 2 to be cleaned, which is determined by the vehicle movement 12.

The vehicle movement 12 can be controlled by the autonomous drive control device 80 expediently not only in terms of the direction of travel, but also in terms of the driving speed. In this way, the driving speed can be adjusted, for example, to the degree of contamination of the ground area. In heavily contaminated areas, the driving speed can be reduced in order to intensify the laser cleaning. In addition or alternatively, the laser parameters can also be adjusted, for example by reducing the irradiation distance by correspondingly controlling the positioning device 44.

In a preferred embodiment, the control electronics 10 can perform a learning run in order to record and store contamination-dependent data that can be retrieved for later comparable cleaning tasks. For example, during such a learning run, a temporary stop and/or slow driving may be performed in order to record the desired data using the vehicle sensor system 4. This comprises a self-learning system that enables particularly effective laser cleaning tailored to requirements.

The power source 38 also expediently supplies the electrical energy for operating the vehicle sensor system 4 and the control electronics 10.

For particularly high positioning accuracy, it is advantageous if the control electronics 10 are equipped with navigation electronics 5 of a satellite navigation system, which is expediently a GPS system, as illustrated in the example. In connection with one or more base stations that can be installed or are installed at the location where the cleaning vehicle 8 is used, which are not further illustrated in the drawing, position reference data can be provided that can be compared with the satellite data by the navigation electronics 5 of the control electronics 10, so that a differential navigation system with particularly high accuracy can be used.

The vehicle sensor system 4 preferably contains at least one sensor from the group of ultrasonic sensors 4a, infrared sensors 4b, optoelectronic sensors 4c, radar sensors 4d and impact sensors 4e. The level of equipment may vary depending on the desired driving and cleaning accuracy, wherein, as a rule, not all sensor types will be installed and, expediently, sensors of one or more sensor types will be present multiple times, in particular with different detection directions.

A very good assessment of the surroundings, whether in terms of possible obstacles in the path or in terms of the nature of the ground area 2, can be achieved if the vehicle sensor system 4, in accordance with the illustrated embodiment, additionally or alternatively to the aforementioned sensors, contains at least one camera 4f.

It is also advantageous if the vehicle sensor system 4 connected to the control electronics 10 comprises at least one sensor designated as a contamination sensor 4g, which is capable of detecting the contamination located on the ground area 2 to be cleaned.

Contamination detection can be performed purely visually, for example, based on the appearance of the contamination still present on ground area 2, in which case at least one contamination sensor 4g can be designed as a camera. The camera image captured is compared with reference images stored in a memory of the control electronics in order to determine, for example, the type of contamination and/or the degree of contamination. In addition or alternatively, at least one contamination sensor 4g may comprise an analysis function and be capable of analysing the type and/or intensity of the contamination vaporised by the laser cleaning process. In particular, sensor equipment for performing fluorescence spectroscopy is advantageous here.

The information determined by the at least one contamination sensor 4g may also relate to the local distribution of the contaminants and the cleaning process.

The control electronics 10 may process the information from the at least one contamination sensor 4g in a manner comparable to the data from the other components of the vehicle sensor system 4 for the operation of the laser cleaning device 24.

Various cleaning programmes can be stored in the control electronics 10, which can be called up depending on the data from the vehicle sensor system 4 and contain various cleaning parameters, for example with regard to the driving speed of the cleaning vehicle 8 and/or the alignment and/or positioning of the laser radiation output unit 35. The cleaning device 1 thus enables intelligent programme selection in connection with automatic contamination detection.

Process reliability and cleaning quality can be further optimised through continuous monitoring and/or logging. For example, the control electronics 10 are capable of continuously or on demand, in particular via radio, transmitting data to an external monitoring device, which is preferably assigned to the base station mentioned above.

In the drawing, the aforementioned components 4a-4f of the vehicle sensor system 4 are only indicated schematically, as there are many possibilities for a favourable selection and distribution, which can be selected as required during the manufacture of the cleaning vehicle 8.

In order to enable fully automatic, or at least highly automated, operation of the cleaning device 1, whether for controlling the vehicle movement 12 of the cleaning vehicle 8 and/or for controlling the cleaning operation of the laser cleaning device 24, it is expedient for the control electronics 10 to be equipped with artificial intelligence (AI) 91 in accordance with the illustrated embodiment.

The artificial intelligence 91 is capable of making decisions and controlling the cleaning vehicle 8 according to the situation, as well as operating the laser cleaning device 24 according to the situation. The data determined by the vehicle electronics 4 is taken into account, as is the location data provided by the optionally used satellite navigation system.

Particularly in the area of the top of the vehicle 16d, the shielding housing 62 expediently comprises a cover 68 which can be removed if necessary to allow access to the working chamber 64. At least one locking element 69 holds the cover 68 in a closed state as shown in the drawing. After manually unlocking the locking element 69, the cover 68 can be removed to assume an open state, for example by completely removing it from the remaining part of the shielding housing 62 or by pivoting it around a hinge mechanism 72.

The open state of the cover 68 allows, for example, the laser radiation output unit 35 to be installed and removed. The flexible line assembly 27 and the flexible suction pipe 34 are connected to the cleaning vehicle 8 in particular via the cover 68.

When the operating control 52 is actuated, electrical control signals are forwarded from the laser radiation output unit 35 to the laser control device 30 via at least one electrical signal line 61, which is designed as part of the flexible line assembly 27, and the laser control device 30 then specifies the operating state of the laser 25.

Preferably, the cleaning vehicle 8 is equipped with a safety device 73 which, depending on the situation, can prevent the laser 25 from being activated in order to avoid personal injury caused by laser radiation.

For example, the safety device 73 contains two components, namely a ground detection device 74 and a cover detection device 75, although only one component may be present.

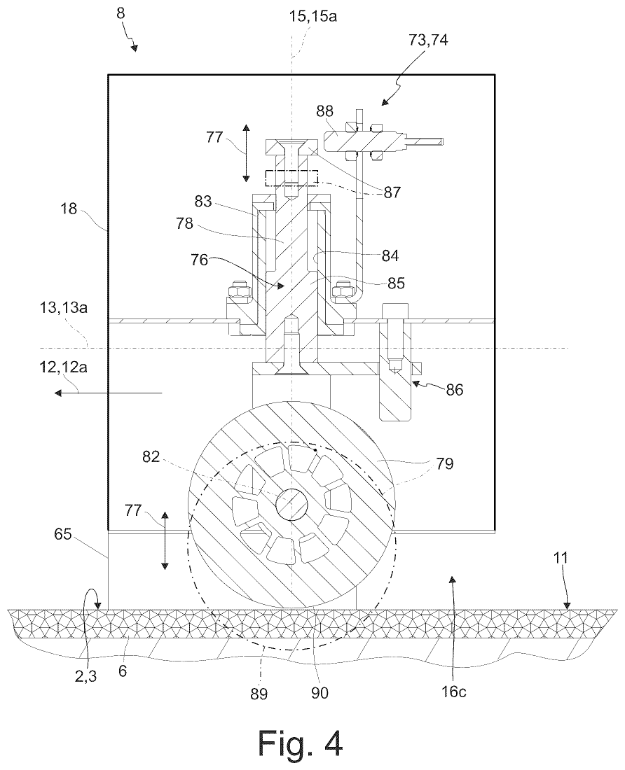

The ground detection device 74, which is particularly clearly visible in FIG. 4, is designed to detect the position of use, in which the castor wheels 17 are standing on the ground 11, and a position of non-use, in which the castor wheels 17 are not standing on the ground 11.

The cover detection device 75, which is particularly evident from FIG. 3, allows the closed state and the open state of the cover 68 to be detected.

The safety device 73 is connected via an electrical signal line, which is not further illustrated and is designed as part of the flexible line assembly 27, to the laser control device 30, which puts the laser 25 into a standby state that allows it to be activated, when the ground detection device 74 detects the position of use and the cover detection device 75 simultaneously detects the closed state of the cover 68. In a case where the ground detection device 74 defines the position of non-use of the cleaning vehicle 8 and/or the cover detection device 75 defines an open state of the cover 68, the laser 25 is placed in a blocking state by the laser control device 30, in which its activation is prevented. In the blocking state, therefore, actuation of the operating control 52 has no effect whatsoever.

According to the illustrated advantageous design, the ground detection device 74 has a sensing unit 76 that is movable relative to the castor wheels 17 and, accordingly, also relative to the vehicle chassis 18 in the vehicle height direction 15a. The movement that can be performed by the sensing unit 76 is referred to as the sensing movement 77 and is illustrated in FIG. 4 by double arrows. The sensing movement 76 is, for example, a linear movement, although in principle it could also be a swivel movement, for example.

The sensing unit 76 has a holding unit 78 and a sensing wheel 79 rotatably mounted on the holding unit 78. The sensing wheel 79 can rotate relative to the holding unit 78 about an axis of rotation 82 extending in the vehicle transverse direction 14a.

The sensing wheel 79 is located on the bottom of the vehicle 16c, specifically in an area between the four castor wheels 17.

The sensing unit 76 is movably mounted on the vehicle chassis 18 via the holding unit 78 to enable the sensing movement 77. For example, the holding unit 78 is movably mounted in a storage unit 83 attached to the vehicle chassis 18 in a manner that allows movement in the vehicle height direction 15a. For example, the storage unit 83 has a cylindrical guide hole 84 in which the holding unit 78 extends with a guide section 85 that has a cylindrical shape complementary to the guide hole 84. An optional anti-rotation device 86 ensures that the sensing unit 76 maintains its alignment with the axis of rotation 82 parallel to the vehicle transverse axis 14, regardless of its height position relative to the vehicle chassis 18.

The holding unit 78 has a trigger element 87, referred to below as the first trigger element 87 for better differentiation, which follows the sensing movement 77 and, during this sensing movement 77, performs a relative movement with respect to a position sensor 88 arranged in the vicinity and fixed in relation to the vehicle chassis 18, referred to below as the first position sensor 88 for the sake of differentiation.

Due to its weight, the sensing unit 76 and thus also the sensing wheel 79 are preloaded into a lowered locking state 89, which extends downwards beyond the castor wheels 17 and is indicated by dotted lines in FIG. 4. The locking state 89 is present when the cleaning vehicle 8 is lifted off the ground 11 with its castor wheels 17.

From the locking state 89, the sensing wheel 79 and, with it, the entire sensing unit 76 can be moved by the sensing movement 77 into an unlock position 90 illustrated by solid lines. The unlock position 90 is achieved by the sensing wheel 79 being pressed upwards by the ground 11 when the cleaning vehicle 8 is parked on said ground 11.

The sensing unit 76 is equipped, in particular, with the first trigger element 87 on the holding unit 78, which follows the sensing movement 77 and in the vicinity of which the first position sensor 88 is arranged on the vehicle chassis 18. In the locking state 89, the first trigger element 87 is so far away from the first position sensor 88 that the latter is deactivated, which signals the position of non-use. In the unlock position 90, the first position sensor 88 is actuated by the first trigger element 87, so that a sensor signal signalling the position of use is output.

The unlock position 90 is characterised in particular by the fact that the sensing wheel 79 is positioned at least substantially at the same height as the castor wheels 17. More precisely, in the unlock position 90, the contact area between the sensing wheel 79 and the ground 11 lies at least substantially in the above-mentioned contact plane of the castor wheels 17.

Expediently, the sensing wheel 79 is arranged in the vicinity of the laser radiation exit area 37, wherein it is placed, for example, in the vehicle transverse direction 14a next to the laser radiation exit area 37. Preferably, the sensing wheel 79 and, in particular, the entire ground detection device 74 are located outside the working chamber 64.

The cover detection device 75 has, for example, a trigger element 93 arranged on the cover 68 and designated as a second trigger element 93 for better differentiation, and a position sensor 94 which is stationary relative to the vehicle chassis 18 and designated as a second position sensor 94 for better differentiation. When the cover 68 is in the closed position, the second position sensor 94 is actuated by the second trigger element 93, causing it to output a corresponding sensor signal to the laser control device 30. When the cover 68 is in its open state, the second trigger element 93 is removed from the second position sensor 94, so that no sensor signal is emitted, which is interpreted by the laser control device 30 as the cover 68 being closed.

The two position sensors 88, 94 are connected in the laser control device 30 in such a way that the laser 25 is only put into the standby state when the first position sensor 88 detects the position of use of the cleaning vehicle 8 and the second position sensor 94 detects that the cover 68 is in the closed state.

The detection measures mentioned are expediently carried out without contact. For example, the first and second trigger elements 87, 93 are each a permanent magnet and the first and second position sensors 88, 94 are each a proximity sensor that responds to a magnetic field, for example a Hall sensor.

It should be added that the sleeve-shaped protective wall 65 preferably comprises a rectangular and, in particular, square cross-sectional contour, but in principle it can also be round and, in particular, circular in contour.

1. A cleaning device for cleaning ground areas, comprising:
a cleaning vehicle which comprises a plurality of drive castor wheels in the area of a bottom of the vehicle, at least one of which is designed as a drive castor wheel, which can rotationally be driven by an electro-motor operated drive device located on board the cleaning vehicle in order to cause a vehicle movement of the cleaning vehicle across a ground area to be cleaned; and
a laser cleaning device which comprises a laser designed to generate laser radiation and a laser radiation output unit located on board the cleaning vehicle and following in its vehicle movement,
wherein, during a cleaning operation of the laser cleaning device, the laser can generate laser radiation which exits at a laser radiation exit area of the laser radiation output unit and which can be directed in the area of the bottom of the vehicle to remove contaminants on an area of the ground area to be cleaned located below the cleaning vehicle,
wherein the cleaning device is equipped with a device for autonomous driving of the cleaning vehicle, which has a control system for autonomous driving of the cleaning vehicle and is connected to the control system of the cleaning vehicle, and
wherein the cleaning device is equipped with a device for autonomous vehicle movement of the cleaning vehicle, which contains control electronics located on board the cleaning vehicle and networked with the drive device and the vehicle sensor system of the cleaning vehicle.

2. The cleaning device according to claim 1, wherein the cleaning device is equipped with a device for autonomous cleaning operation of the laser cleaning device, which is functionally coordinated with the vehicle movement- of the cleaning vehicle, wherein the control electronics are also networked with the laser cleaning device.

3. The cleaning device according to claim 2, wherein the device for autonomous cleaning operation of the laser cleaning device contains a switch actuator networked with the control electronics for alternately activating and deactivating the laser.

4. The cleaning device according to claim 1, wherein the control electronics are equipped with artificial intelligence.

5. The cleaning device according to claim 1, wherein the vehicle sensor system contains one or more sensors from the group consisting of ultrasonic sensors, infrared sensors, optoelectronic sensors, radar sensors and impact sensors.

6. The cleaning device according to claim 1, wherein the vehicle sensor system contains at least one camera suitable for detecting the vehicle surrounding the cleaning vehicle.

7. The cleaning device according to claim 1, wherein the vehicle sensor system networked with the control electronics comprises at least one contamination sensor by means of which contamination located on the ground area to be cleaned can be detected.

8. The cleaning device according to claim 1, wherein the control electronics contain navigation electronics for a satellite navigation system.

9-12. (canceled)

12. The cleaning device according to claim 1, wherein at least one manually operable manual actuation element of a manual actuation device for manually activating and deactivating the laser is arranged on the handle, which is mechanically coupled to the laser radiation output unit via a coupling device.

13. The cleaning device according to claim 1, wherein the laser radiation output unit is designed as a laser pistol which has a pistol main section comprising a laser radiation exit area and a pistol handle extending transversely from the pistol main section, wherein the pistol handle is assigned an operating control that can be actuated by selectively pressing or releasing it and which enables the laser to be activated and deactivated.

14. (canceled)

15. The cleaning device according to claim 1, wherein the castor wheels are designed partly as swivel castor wheels and partly as non-swivel fixed castor wheels, wherein at least one of the fixed castor wheels is designed as a drive castor wheel.

16. (canceled)

17. The cleaning device according to claim 1, wherein the cleaning vehicle comprises a laser radiation shielding device which shields the laser radiation exit area from view to the surroundings, except for an area on the bottom of the vehicle that faces downwards when the cleaning vehicle is used as intended.

18-22. (canceled)

23. The cleaning device according to claim 1, wherein the laser radiation output unit comprises a laser optic arranged upstream of the laser radiation exit area.

24. The cleaning device according to claim 1, wherein the cleaning vehicle comprises a vehicle chassis on which both the castor wheels and the laser radiation output unit are arranged.

25. The cleaning device according to claim 1, wherein the laser radiation output unit is assigned a positioning device of the cleaning vehicle, by means of which a working position of the laser radiation output unit within the cleaning vehicle can be variably adjusted.

26-27. (canceled)

28. The cleaning device according to claim 1, wherein the laser cleaning device is equipped with a suction device for suction cleaning ablation media caused by the laser radiation during a cleaning process in the area of the laser radiation output unit.

29-30. (canceled)

31. The cleaning device according to claim 1, wherein the cleaning vehicle comprises a safety device which prevents activation of the laser under certain usage situations of the cleaning vehicle.

32. The cleaning device according to claim 31, wherein the safety device comprises a ground detection device by means of which a position of use of the cleaning vehicle standing with the castor wheels on a ground and a position of non-use of the cleaning vehicle wherein the castor wheels are not standing on a ground can be detected, wherein the laser can be set to a standby state enabling its activation as a result of detection of the position of use and to a blocking state preventing its activation as a result of detection of the position of non-use.

33-34. (canceled)

35. The cleaning device according to claim 31, wherein a shielding bousing (62) comprises a cover (68) that can be removed to access the working chamber (64) and the safety device comprises a cover detection device by means of which a closed state of the cover closing the working chamber and an open state of the cover making the working chamber accessible can be detected, wherein the laser can be set to a standby state enabling its activation as a result of detection of the closed state and to a blocking state preventing its activation as a result of detection of the open state.

36. A cleaning method for cleaning ground areas using a cleaning device, wherein the cleaning device comprises: a cleaning vehicle which comprises a plurality of drive castor wheels in the area of a bottom of the vehicle, at least one of which is designed as a drive castor wheel, which can rotationally be driven by an electro-motor operated drive device located on board the cleaning vehicle in order to cause a vehicle movement of the cleaning vehicle across a ground area to be cleaned;
and a laser cleaning device which comprises a laser designed to generate laser radiation and a laser radiation output unit located on board the cleaning vehicle and following in its vehicle movement,
wherein, during a cleaning operation of the laser cleaning device the laser can generate laser radiation which exits at a laser radiation exit area of the laser radiation outper unit and which can be directed in the area of the bottom of the vehicle to remove contaminants on an area of the ground area to be cleaned located below the cleaning vehicle, and
wherein the cleaning device is equipped with a device for autonomous driving of the cleaning vehicle, which has a control system for autonomous driving of the cleaning vehicle and is connected to the control system of the cleaning vehicle, and
wherein the cleaning device is equipped with a device for autonomous vehicle movement of the cleaning vehicle which contains control electronics located on board the cleaning vehicle and networked with the drive device and the vehicle sensor system of the cleaning vehicle,
the method comprising: the cleaning vehicle performing an autonomous vehicle movement across the ground area to be cleaned, so that the ground area is irradiated by the laser radiation exiting from the laser radiation exit area when the laser is activated beneath the cleaning vehicle, thereby removing contaminants from the ground area.

37. (canceled)
